(19) United States
(12) Patent Application Publication
(10) Pub. No.: US 2025/0322254 A1
(43) Pub. Date: Oct. 16, 2025

(54) TRAINING A POPULATION OF ADVERSARIAL NEURAL NETWORKS TO IMPROVE A BASE NEURAL NETWORK

(71) Applicant: DeepMind Technologies Limited, London (GB)

(72) Inventors: Roma Patel, Providence, RI (US); John Paul Agapiou, London (GB); Marta Garnelo Abellanas, London (GB); Andrea Tacchetti, London (GB)

(21) Appl. No.: 18/636,971

(22) Filed: Apr. 16, 2024

(51) Int. Cl. G06N 3/094

(52) U.S. Cl. CPC G06N 3/094

(57) ABSTRACT

Methods, systems, and apparatus, including computer programs encoded on a computer storage medium, for training a base neural network using adversarial data in accordance with generating outputs that align with one or more downstream task criteria. In one aspect, a system comprises a method for training a population of adversarial neural networks using a base neural network by processing a received adversarial input using an adversarial neural network to generate one or more adversarial base network inputs, processing the one or more adversarial base network inputs using the base neural network to generate one or more respective outputs for each adversarial base network input, determining one or more adversarial rewards for the outputs that measure a likelihood of violating a corresponding set of downstream task criteria and training the adversarial neural network in accordance with the training task by optimizing an adversarial reinforcement learning loss function based at least on the adversarial reward.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can train a base neural network (“base network”) using adversarial data in accordance with generating outputs that align with one or more downstream task criteria. In particular, the system can align the performance of the base network with the downstream task criteria by augmenting the training data for the base network with adversarial data from an evolving population of adversarial neural networks (“adversarial networks”) that can be trained to minimize the alignment of base network outputs with respect to one or more of the downstream task criteria. More specifically, the population of adversarial networks can be trained to generate base network inputs that cause the base network to generate base network outputs that violate the downstream task criteria.

Generally, the downstream task criteria can relate to the base network output satisfying one or more constraints or rules that relate to the downstream task. As an example, the downstream task criteria can include an indicator for maintaining a stable output, fulfilling a set of safety criteria, adhering to quality control, e.g., an output not being distorted or noisy for image generation tasks, or preserving performance when faced with distributional shift. In particular, the one or more downstream task criteria can aim to guardrail the base network output within an allowable space of outputs and increase the likelihood that performance in an unseen realm of input data remains acceptable.

The adversarial data for training the base network can be generated through “red-teaming” in order to improve the base network's performance with respect to the downstream task criteria. More specifically, the base network and the population of adversarial neural networks can be jointly trained on opposing objectives with respect to the measure of violating the downstream task criteria: the system can train the population of adversarial neural networks to generate adversarial training data for the base neural network that aims to violate the downstream task criteria, and the base network can be penalized for generating an output that violates the downstream task criteria. In particular, the system can provide a measure of a likelihood of violating the downstream task criteria by evaluating the base network output, and the system can train the population of adversarial networks with an objective of maximizing the measure of violating the downstream task criteria, e.g., to minimize the alignment of the base network outputs with respect to the downstream task criteria.

In particular, each of the adversarial neural networks in the population can be assigned a respective training task that targets a specific subset of the downstream task criteria in order to generate more robust adversarial data for training the base network. In this case, the population of adversarial neural networks can function together as a unit, e.g., a cooperative league, to align the base network with the downstream task criteria through the generation of increasingly diverse and targeted adversarial data. The diversity of the training data can increase the robustness of the base network in deployment.

According to a first aspect there is provided a method performed by one or more computers for training a population of adversarial neural networks using a base neural network, wherein training the population comprises, at each of a plurality of training iterations and for each adversarial neural network in the population: receiving an adversarial input, processing the adversarial input using the adversarial neural network to generate one or more adversarial base network inputs for the base neural network, wherein each adversarial base network input is generated in accordance with a respective training task that requires generating adversarial base network inputs that violate the one or more downstream task criteria, processing the one or more adversarial base network inputs using the base neural network to generate one or more respective adversarial base network outputs for each adversarial base network input, evaluating the one or more adversarial base network outputs based at least on an adversarial reward comprising a measure of a likelihood of violating the one or more downstream criteria, and training the adversarial neural network in accordance with the respective training task by optimizing an adversarial reinforcement learning loss function based at least on the adversarial reward.

Particular embodiments of the subject matter described in this specification can be implemented so as to realize one or more of the following advantages.

The techniques described in this specification can enable the training of a base neural network to align with one or more downstream task criteria using adversarial data produced by iteratively training a population of adversarial neural networks. The population of adversarial neural networks can evolve to generate new and more diverse adversarial data to target the downstream criteria, thereby enhancing the robustness of the base network with respect to the downstream task criteria. In particular, training the base neural network and the population of adversarial neural networks on opposing objectives enhances the robustness of training the base neural network since the data produced by the population evolves over each training iteration to more expertly target the downstream task criteria. More specifically, training the base neural network with evolving adversarial data from a population of adversarial neural networks is more effective than training the base neural network with static adversarial data produced by a single or multiple static adversarial neural networks.

Relatedly, the techniques of this specification can be used as a data generation tool to generate new adversarial datasets using the adversarial neural networks for other training tasks. In this case, the base network can be used to score the output of the population of adversarial networks to evolve the population to enhance the robustness of training in a downstream task, e.g., a task that does not include training the base network.

Additionally, training a population of adversarial agents to generate adversarial data that targets the downstream task criteria can be suitable for applications in which one or more of the downstream task criteria can be characterized as subjective. Using adversarial data that targets the downstream task criteria to train the base network is more straightforward than customizing a loss function to achieve base network alignment with the downstream task criteria. In particular, training with adversarially-generated data can facilitate base network training when quantifying the downstream task criteria as an additional component of the loss function is difficult or not possible.

In an example, the base neural network can be a language processing model, e.g., an attention-based model, e.g., a transformer large language model. In some cases, trained language processing models can exhibit biased and harmful behavior when prompted with certain types of sentences that can reveal biases learned during training. When deployed as chatbots, search engines, or other user-serving applications this behavior can be harmful to humans that interact with such models. In another example, the base network can be a multimodal model, e.g., a vision-language model (VLM) that can process an image or sequence of images in a video to generate an intermediate representation of the image and perform an image processing task. In some cases, trained VLMs can exhibit biased and harmful behavior based on biases present in labels used for training. The techniques described in this specification can be used to steer the training of a language processing model or a multimodal model toward safer and non-toxic outputs even when faced with adversarial prompts.

Furthermore, the techniques of this specification can be used to train the base network and the population of adversarial neural networks from the same pretrained model, thereby saving compute with respect to alternative approaches, e.g., with respect to training each model from independently initialized parameter values. As an example, the base network and adversarial networks can be pretrained neural networks and the system can freeze respective subsets of the parameters of each network before fine-tuning, e.g., specialized training, begins. In particular, fine-tuning can include training the base network to generate outputs that align with the downstream task criteria and training the adversarial networks to generate adversarial base network inputs that minimize alignment with the downstream task criteria. In the particular example in which the base network and the population of adversarial neural networks are language processing models, finetuning from the same pretrained model, e.g., a foundation model, instead of training from the beginning can drastically reduce the resources required to train the base network and adversarial networks since each language processing model can have billions or trillions of parameters to update each training iteration.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a system diagram of an example alignment training system that can train a base network in accordance with one or more downstream task criteria.

FIG. 1B depicts an example overview of training a visual language model using the example alignment training system of FIG. 1A.

FIG. 2 is a system diagram of an example evolutionary adversarial training system that can jointly train the base network and the population of adversarial neural networks using reinforcement learning.

FIG. 3 is a flow diagram that shows how the evolutionary adversarial training system of FIG. 2 can be used to robustly train an example base language processing model with respect to a set of downstream task criteria.

FIG. 4 is a flow chart of an example process for jointly training the base network and the population of adversarial neural networks over a number of training iterations.

FIG. 5 is a flow chart of an example process for training a population of adversarial neural networks to generate robust training data for a base network in line with one or more downstream task criteria.

FIG. 6 illustrates an example language processing model architecture implementation of a base network or adversarial network that can be fine-tuned using the example evolutionary adversarial training system of FIG. 2.

FIG. 7 demonstrates how training the evolving population of adversarial neural networks to generate adversarial prompts using the training system of FIG. 2 can improve base network performance.

Like reference numbers and designations in the various drawings indicate like elements.

### DETAILED DESCRIPTION

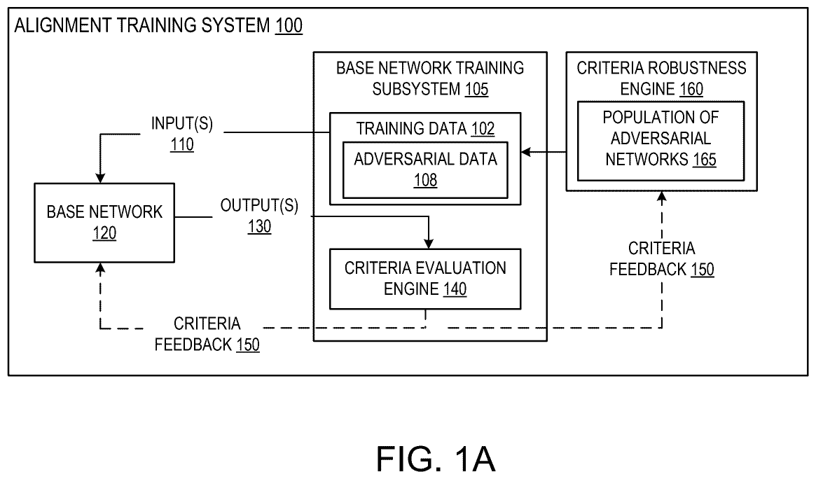

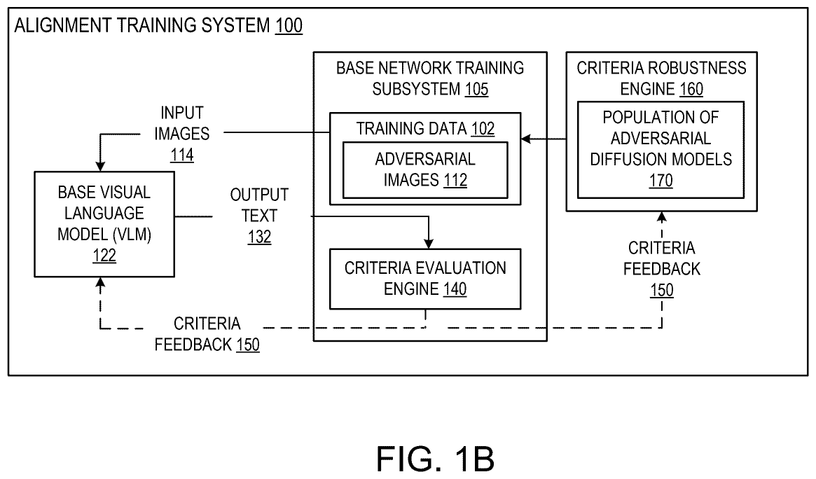

FIG. 1A shows an example alignment training system 100. The alignment training system 100 is an example of a system implemented as computer programs on one or more computers in one or more locations in which the systems, components, and techniques described below are implemented.

The alignment training system 100 can train a base neural network (“base network”) 120 to generate outputs 130 that align with, e.g., adhere to, one or more downstream task criteria. In particular, the alignment training system 100 can provide the base network 120 with an input 110 that the base network 120 can process to generate an output 130 that the system can evaluate with respect to the downstream task criteria.

The downstream task criteria can specify certain desired properties of the output 130 with respect to one or more downstream tasks, e.g., criteria that relate to ensuring the quality and robustness of the output 130 for downstream use cases. For example, the downstream task criteria can relate to maintaining a stable output within allowable values, fulfilling a set of safety criteria, adhering to quality control, e.g., an output not being distorted or noisy for image generation tasks, or preserving performance when faced with distributional shift. In some cases, evaluating the output 130 with respect to the downstream task criteria can depend on one or more of the type of base network 120 being trained and the type of output 130 generated.

The training data 102 can include any appropriate type of input data with respect to the one or more downstream tasks the output 130 relates to, e.g., the training data 102 can include one or more of numerical data, categorical data, dialogue data, audio data, image data, etc. In some cases, the base network 120 can process an input 110 including one or more types of data to generate an output 130 including one of the same types of data. In other cases, the base network 120 can process an input 110 including one or more types of data to generate an output 130 including one or more different types of data.

As an example, a downstream task can include generating a text that aligns with a set of safety criteria including a specification that the text does not contain medical advice, aggressive statements, or bias towards specific groups. In this case, the base network input 110 can include one or more prompts that can be processed to generate the text.

As another example, a downstream task can include generating an image to align with downstream task criteria including a measure of clarity and sharpness. In this case, the base network input 110 can include one or more categories of objects to be included in the image, numerical data specifying a distance between the one or more objects, and an audio clip that relates a theme for the generated image.

As yet another example, a downstream task can include generating predicted control set point values of an industrial machine to align with the downstream task criteria including an upper and lower bound of allowable values, e.g., in accordance with safe operations of the industrial machine. In this case, the base network 120 input 110 can include time series values of previous set points as well as other machines that the set point impacts.

The base network 120 can have any appropriate machine learning architecture, e.g., a neural network, that can be configured to process the input 110 to generate an output 130 in accordance with the training task. In particular, the base network 120 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some situations, the base network 120 can be referred to as an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the base network 120 can be an auto-regressive Transformer-based neural network that includes (i) a plurality of attention blocks that each apply a self-attention operation and (ii) an output subnetwork that processes an output of the last attention block to generate the score distribution.

In this example, the base network 120 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv:2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

The base network training subsystem 105 can train the base network 120 using training data 105 that has been augmented with adversarial data 108. More specifically, the robust base network training system 105 can maintain diverse training data 102 to enhance the robustness of the base network's performance with respect to the one or more downstream task criteria. In particular, the training data 102 can include adversarial data 108 that is curated with respect to the downstream tasks, e.g., by upweighting the outliers of a population of data to ensure the model operates within appropriate constraints, by including purposefully antagonistic data to ensure the model does not respond in harmful ways, etc.

The adversarial data 108 can include adversarial data generated by a criteria robustness engine 160. In the particular example depicted, the criteria robustness engine 160 can include a population of one or more adversarial neural networks (“adversarial networks”) 165 that generate outputs that aim to target the one or more downstream task criteria, e.g., by generating adversarial base network inputs that cause the base network 120 to generate adversarial base network outputs 130 that violate the one or more downstream task criteria.

As described above with respect to the base network 120, the one or more adversarial neural networks 165 can have any appropriate machine learning architecture. In particular, each adversarial neural network can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some cases, the one or more adversarial neural networks 165 can be implemented using the same machine learning architecture, e.g., the one or more adversarial neural networks 165 can be language processing neural networks. For example, the one or more adversarial neural networks 165 can be implemented using the same architecture. In some cases, the population of adversarial neural networks 165 can be implemented using the same machine learning architecture as the base network 120. For example, the one or more adversarial neural networks 165 and the base network 120 can be implemented as attention-based language models. In other cases, the population of adversarial neural networks 165 can be implemented using a different machine learning architecture than the base network 120. For example, the population of adversarial networks 165 can be implemented as diffusion networks and the base network 120 can be implemented as a multimodal model, e.g., a vision-language model (VLM), e.g., as depicted in FIG. 1B.

The population 165 can be trained using one or more adversarial training tasks. As an example, the one or more adversarial training tasks can be part of an adversarial training task strategy, e.g., a red-teaming strategy. In particular, the criteria robustness engine 160 can assign adversarial training tasks to each of the adversarial networks in the population 165 as part of the red-teaming strategy. As an example, the population of adversarial networks 165 can function as a unit, e.g., as a cooperative league, and be trained with a broad adversarial task to target all of the downstream task criteria. As another example, the population of adversarial networks 165 can be partitioned into subsets of one or more adversarial networks and trained with an adversarial task to target a specific subset of the downstream task criteria. As yet another example, each of the adversarial networks 165 can be trained to target a specific downstream task criterion.

More specifically, the population of adversarial networks 165 can be trained to generate adversarial data 108 that minimizes the alignment of the output 130 with respect to the one or more downstream task criteria. In particular, the base network training subsystem 105 can ensure the alignment of the base network output 130 with the downstream task criteria using the criteria evaluation engine 140, e.g., the system 100 can process the output 130 using the criteria evaluation engine 140 to provide criteria feedback 150 to the base network 120 and the criteria robustness engine 160.

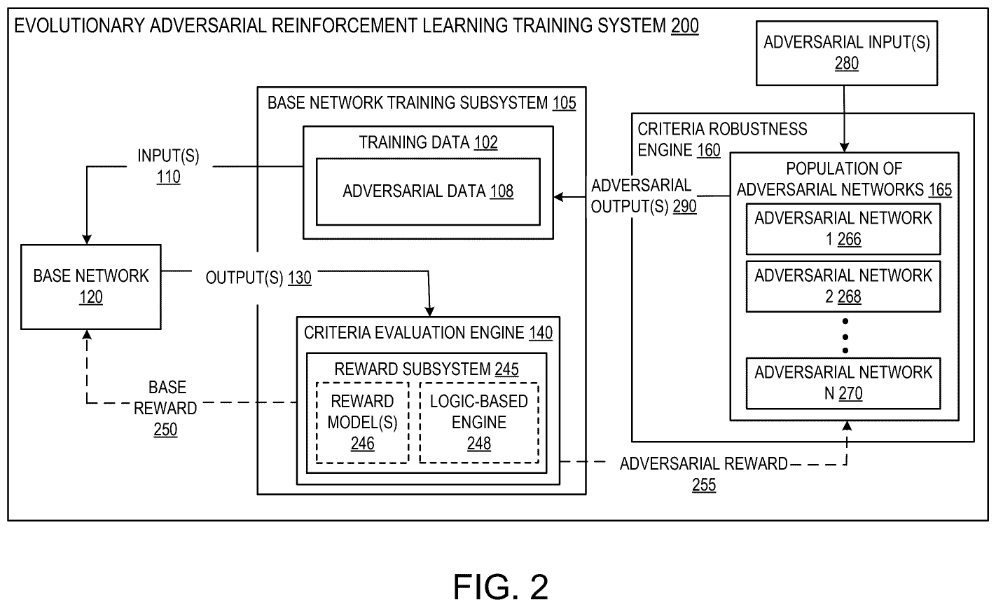

As an example, the criteria evaluation engine 140 can be implemented to process the output 130 and generate the criteria feedback 150 using a simple rules-based system to ensure that the output 130 aligns with the downstream task criteria. As another example, the criteria evaluation engine 140 can be implemented using one or more machine learning reward models, e.g., machine learning models that can evaluate or score the output 130 with respect to the downstream task criteria. In a particular example detailed in FIG. 2, the criteria evaluation engine 140 can include a set of one or more reward models that can be configured to provide criteria feedback 150 specifically regarding the downstream tasks.

The criteria feedback 150 can inform both the base network 120 and population 165 training, e.g., the base network 120 and the population of adversarial neural networks 165 can be jointly trained on opposing objectives using the criteria feedback 150. In particular, the base network 120 can be trained to maximize the alignment of the output 130 with respect to the downstream task criteria and the population 165. Additionally, the criteria robustness engine 160 can use the criteria feedback 150 to evaluate the performance of the adversarial networks in the population 165 with respect to the one or more implemented adversarial training tasks and train the population 165 to minimize the alignment of the output 130 with respect to the one or more of the downstream task criteria according to respective adversarial training tasks.

More specifically, the criteria robustness engine 160 can process the criteria feedback 150 to inform the generation of adversarial data 108. In particular, the criteria robustness engine 160 can modify the adversarial training task strategy for generating training data 105 in accordance with a measure of base network output 130 alignment with respect to the downstream task criteria. The alignment training system 100 can therefore evolve the population of adversarial networks 165 to generate more targeted adversarial data 108 based on base network 120 performance, e.g., the ability of the base network 120 to generate outputs 130 that adhere to the downstream task criteria even when processing adversarial data as input, and can enhance the robustness of the base network 120 by training the base network 120 on increasingly more diverse and targeted data.

In particular, the system 100 can train the base and adversarial networks through reinforcement learning, e.g., by jointly training the base network 120 to optimize a base reinforcement learning loss function and the population of adversarial networks 165 to optimize an adversarial reinforcement learning loss function. In this case, the criteria feedback 150 can include respective rewards for both the base network 120 and the population of adversarial networks 165. An example reinforcement learning training process will be covered in further detail in FIG. 2.

FIG. 1B depicts an example overview of training a visual language model to perform using a population of adversarial diffusion models, e.g., using the example alignment training system 100 of FIG. 1A.

In the particular, the base network can be a base visual language model (VLM) 122 that can be configured to process an image or sequence of images in a video to generate an intermediate representation of the image and perform an image processing task. For example, the base network can be a contrastive language-image pre-training (CLIP) model, a vision transformer (ViT), a unified image-to-image translation (UNIT) model, or an attention generative adversarial network (AttnGAN).

As an example, the image processing task can involve generating an output that requires reasoning, e.g., spatio-temporal reasoning, to respond to a natural language query input, e.g., relating to a moving image (video). For example, such a query may require predictive reasoning (“what will happen next”), counterfactual reasoning (“what would happen in a different circumstance”), explanatory reasoning (“why did something happen”), or causal reasoning generally. For example, the image representation can be used to detect objects in the video frames and provide information relating to the detected objects in response to a query, e.g., a request for a prediction of a future event or state relating to one or more of the objects (e.g., “will objects X and Y collide?”), or a request for conditional or counterfactual information relating to one or more of the objects (e.g., “what event would [not] happen if object X is modified, moved or absent?”), or a request for analysis of the video frames to determine a property or characteristic of one or more of the objects (e.g., “how many objects of type Z are moving?”). The output may, for example, be in the form of a yes/no answer, or may define a probability distribution over a set of possible answers; or the response may define the location of an object. Such a base network can be used to predict whether or not two objects will collide, or how this may be avoided. The output may be used e.g., to provide a warning, to control motion of one or more of the objects, or both.

In the particular example depicted, the imaging processing task is an image-to-description task, e.g., in which the base VLM 122 processes an image to generate a textual description of the content depicted in the image. For example, the base VLM 122 can process a picture of a Samoyed happily running through a field toward a tennis ball to generate a text description, e.g., “a playful Samoyed running after a ball in the park”. In this case, the population of adversarial networks can be a population of adversarial diffusion models 170 configured to generate adversarial images 112. For example, the population of adversarial diffusion models 170 can be a population of diffusion probabilistic models (DPMs), noise-conditioned score networks, or U-Nets.

More specifically, the adversarial images 112 can be images that are purposefully generated to confound the base VLM 122. In particular, the adversarial images 112 can include configurations of pixels generated using adversarial image methods, e.g., one-pixel attacks, projected gradient descent, transfer-based attacks, fast gradient sign method attacks, etc., that can be cause a slight perturbation of an input token generated from the adversarial images. In particular, the slight perturbation can result in an incorrect intermediate representation of the image used for the image processing task, e.g., predicting the text associated with the image representation.

As discussed in FIG. 1, the base visual language model 122 can process input images 114 including the adversarial images 112 to generate output text 132, e.g., the output text description, which can then be evaluated using the criteria evaluation engine 140 in order to train the base VLM 122 and the population of adversarial diffusion models 170. In this case, the system 100 can train the base VLM 122 to generate correct and non-toxic output text descriptions, despite jointly training the population of adversarial diffusion models 170 to generate increasingly antagonistic adversarial input images 112. In particular, training the base VLM 122 using the population of adversarial diffusion models 170 can increase the robustness of the base VLM 122.

FIG. 2 depicts an example evolutionary adversarial reinforcement learning training system that can be used to jointly train the base network and the population of adversarial networks using one or more reward models. The evolutionary adversarial reinforcement learning training system is an example implementation of the alignment training system 100 of FIG. 1.

As depicted in FIG. 1, the evolutionary adversarial reinforcement learning training system 200 can include the base network training system 105, e.g., for training the base network 120 and the criteria robustness engine 160 that includes a population of one or more adversarial networks 165, e.g., adversarial network 1 266, adversarial network 2 268, adversarial network N 270, etc., In the particular example depicted, each of the adversarial networks 266, 268, 270 can be configured to receive one or more adversarial inputs 280 to generate one or more adversarial outputs 290 that can then be processed as an adversarial base network input 102 by the base network 120.

As an example, the adversarial inputs 280 can include antagonistic data sourced to train the population of adversarial networks 165 to generate adversarial content, e.g., adversarial data, that can cause the base network 120 to generate outputs 130 that do not align with the one or more downstream task criteria. In particular, the antagonistic data can be used to train the population of adversarial networks 165 to generate base network inputs that, when processed, can confound the ability of the base network 120 to generate base network outputs that align with the one or more downstream task criteria.

In the case that the population 165 includes one or more generative models and the base network is a generative model, the adversarial inputs 280 can include antagonistic data that violates one or more of the downstream task criteria, e.g., so the adversarial networks 165 can learn to generate content that can prompt the base network 120 to violate the one or more downstream task criteria. As an example, the adversarial networks 165 can generate prompts demonstrated to cause the base network 120 to generate audio, image, video, text, etc. outputs that do not align with downstream task criteria specifying a certain clarity of output, data with appropriate content, etc. as adversarial data 108.

For example, in an image processing setting, the adversarial inputs 280 can include configurations of pixels, e.g., one-pixel attack images, that can be used to cause the base network 120 to generate an incorrect classification. As another example, in a game-playing setting, the adversarial inputs 280 can be used to generate an adversarial strategy to play against the base network 120. As yet another example, in a multimodal setting, the adversarial inputs 280 can be purposefully adversarial labels, e.g., labels associated with an input image to be processed for caption generation, that can cause the base network 120 to generate a harmful caption as output.

As another example, in the language processing model setting, the adversarial inputs 280 can include antagonistic dialogue data, e.g., one or more curated antagonistic dialogue datasets, e.g., the Anthropic red-team dataset, the BAD dataset, etc. As another example, antagonistic dialogue data can include antagonistic data generated with a variety of methods, e.g., those detailed in “Red Teaming Language Models with Language Models” (Perez, et. al.: arXiv:2202.03286).

In some cases, each of the adversarial networks in the population 165, e.g., adversarial networks 266, 268, and 270, can be configured to process the same adversarial input 280 in order to generate respective adversarial outputs 290. In other cases, the adversarial networks 266, 268, and 270 can process respective adversarial inputs 280 in order to generate different adversarial outputs 290.

In some cases, the base network 120 and the population of adversarial networks 165 can be trained or fine-tuned with synchronous advantage actor-critic (A2C), a common reinforcement learning procedure as detailed in “Asynchronous Methods for Deep Reinforcement Learning” (Mnih et. al.: arXiv:1602.01783). In this case, the reward for the base network 120 and the population of adversarial networks 165 can be generated by the criteria evaluation engine 140, e.g., using a reward subsystem 245. In particular, the reward subsystem 245 can generate a reward for both the base network 120, e.g., the base reward 250, and the population of adversarial networks 165, e.g., the adversarial reward 248, that can be combined with the base reinforcement learning loss function and the adversarial reinforcement learning loss function, respectively. As an example, to address any policy drift over training iterations, the system 200 can apply a Kullback-Leibler (KL) divergence penalty and linearly combine the penalty with the A2C loss. The base network 120 and the adversarial networks 165 can therefore train to generate next tokens that maximize the reward signal coming from the relevant reward models.

More specifically, the system 200 can link the performance of the base network 320, e.g., with respect to one or more downstream task criteria, to the population of adversarial networks 265 using the reward subsystem 245. In particular, the reward subsystem 245 can assign a reward to the output 130 of the base network 120 in order to incentivize the output 130 aligning with the downstream task criteria for the base network 120 and incentivize the output 130 not aligning with the downstream task criteria for the population of adversarial networks 165.

The base network 120 and the population of adversarial networks 165 can therefore train with opposing tasks, e.g., against each other using the base reward 250 and the adversarial reward 255, using an evolutionary training technique over a sequence of training iterations. In particular, the population of adversarial networks 165 can be trained to generate increasingly more diverse and targeted adversarial data that can support the robust training of the base network 120.

In the case of the criteria robustness engine 160 implementing an adversarial training task strategy of targeted rule violation, each adversarial network, e.g., the adversarial networks 366, 368, and 370, can be trained according to respective training tasks. In particular, the adversarial reward 255 can include a vector of probabilities, each corresponding to a violation of a respective rule, and the criteria robustness engine 160 can distribute the corresponding part of the adversarial reward 255 to the corresponding adversarial network in the population 165 to train in accordance with a measure of a likelihood of violating that particular rule. In particular, by specializing each adversarial network to target a particular rule, the system can augment the training data 102 with customized adversarial data 108 in a targeted and direct manner.

The reward subsystem 245 can include one or more of reward model(s) 246 that can predict one or more rewards, a logic-based engine 248 that can calculate one or more rewards for logic-based downstream task criteria, e.g., using an encoded rules-based system, or both reward model(s) 246 and the logic-based engine 248. For example, in the case of using a multi-layer perceptron as a base network to generate predicted control set point values for an industrial machine, the downstream task criteria can include numbers, e.g., specifying the upper and lower bound of allowable values, and the reward subsystem 245 can use the logic-based engine 248 to compare the generated control set point values to the upper and lower bound, to provide an indication of whether or not the output 130 aligns with the downstream criteria.

As another example, in the case of the base network 120 being implemented as a language processing network, e.g., a large language model, the downstream task criteria can include a set of one or more safety criteria for the output 130, e.g., criteria that ensures the output 130 is safe for a human to interact with, and human preference criteria. In this case, the reward subsystem 245 can use the one or more reward models 246 to predict a probability or a vector of probabilities indicating whether or not the output 130 aligns with the safety criteria.

The evolutionary adversarial reinforcement learning training system 200 can train the base network 120 and the population of adversarial networks 165 at each of a number of training iterations using the base reward 250 and the adversarial reward 255. More specifically, the system 300 can train the population of adversarial neural networks 165 to generate more targeted and diverse adversarial data 108 for training the base network to ensure that the output 130 of the base network aligns with the downstream task criteria. In particular, the system 200 can enhance the training of the base network 120 such that the base network can perform robustly even when processing adversarial data 108 as an input.

In particular, at each training iteration, the criteria robustness engine 160 can process adversarial inputs 280 using the one or more adversarial networks in the population 165 to generate one or more adversarial outputs 190. The base network training subsystem 105 can incorporate the adversarial outputs 190 as adversarial data 108 in the training data 102 for the base network. The base network 120 can process one or more input(s) 110 from the training data 102, e.g., including the adversarial data 108, to generate an output 130 that the criteria evaluation engine 140 can evaluate, e.g., using the reward subsystem 245 to generate the base 250 and adversarial 255 rewards. The base reward 250 can inform the training of the base network 120, e.g., by being included as part of a base reinforcement learning loss function. Likewise, the adversarial reward 255 can inform the training of the adversarial networks, e.g., by being included as part of an adversarial reinforcement learning loss function.

In an example, the base network 120 and the adversarial networks 165 can be pretrained with supervision or using reinforcement learning at a zeroth iteration before the parameters of the base network 120 are frozen for the training of the population of adversarial networks 165. In particular, the base network 120 can be trained separately with a generic pretraining dataset that pertains to the downstream task, and the adversarial networks 165 can be pretrained with an antagonistic pretraining dataset. In some cases, either the generic, antagonistic, or both pretraining datasets can include human-generated adversarial data.

In particular, the base network 120 and the population of adversarial networks 165 can alternate training after the zeroth iteration such that the population 165 generates adversarial outputs 290 for a first iteration, receives an adversarial reward 255 based on the base network outputs 130 that were generated, e.g., by processing the adversarial outputs 290 as adversarial base network inputs, for the first iteration, and updates a set of one or more adversarial network parameters based on the adversarial reward 255. Then, the base network 120 can train using training data 102 that includes the adversarial data 108 generated by the adversarial networks 165 in the first training iteration.

The process can repeat iteratively, e.g., each training iteration of the system 200 can evolve the population of adversarial networks 165 to generate more targeted adversarial data 108 based on the performance of the base network 120.

In some cases, a full training iteration can involve the population of adversarial networks 165 training against the most recently trained base network 120. In this case, the base network can be trained with the most recently generated adversarial data 108 before the population 165 processes more adversarial input(s) 280 to generate the next iteration of adversarial output(s) 190. In this case, the system 200 can jointly evolve the base network 120 and the adversarial networks 165 in order to generate increasingly targeted adversarial output(s) 290.

In other cases, the base network 120 can be fully or partially frozen during a training iteration, e.g., one or more parameters of the base network 120 can be held constant and not allowed to update as the population of adversarial networks 165 trains. In a particular example, the system 200 can train the population of adversarial networks 165 using a frozen base network 120 to evolve the adversarial population 165. In particular, the population 165 can be trained against a frozen base network 120 after the completion of the zeroth iteration, e.g., the same frozen base language processing network 120 used to generate outputs 130 in the first iteration, to generate more adversarial output(s) 290, e.g., in order to prevent distributional shift of the generated adversarial output(s) 290.

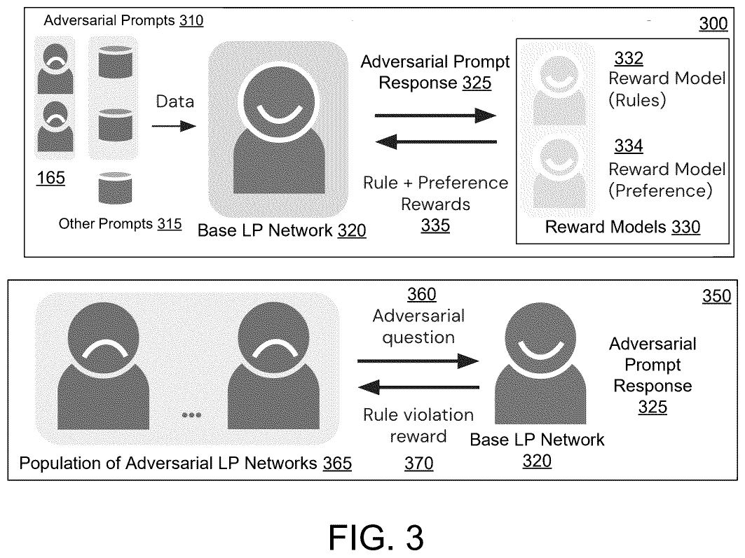

FIG. 3 is a flow diagram that provides an overview for how an evolutionary reinforcement learning training system, e.g., the evolutionary reinforcement learning training system 200 of FIG. 2, can jointly train an example base language processing (LP) network 320 and example population of adversarial language processing (LP) neural networks 365.

As a particular example, the base LP network 320 can be trained using the evolutionary adversarial reinforcement learning training system 200 of FIG. 2 to generate safe prompt responses when prompted with adversarial prompts 310 that aim to violate one or more safety rules included in the downstream task criteria. As an example, the safety rules can include ensuring the response is not offensive, avoids certain topics, prevents data leakage from the training set, and protects sensitive information. As another example, the safety rules can include not giving medical advice, not giving legal advice, and not engaging with aggressive harmful prompts. More specifically, the subjective idea of safety can be evaluated using the criteria evaluation engine 140 and the criteria robustness engine 160 can evolve to test the base LP network's 320 ability to respond in a non-harmful way when faced with evolving adversarial prompts 310 produced by the population of adversarial LP networks 365.

In another example, the base LP network 320 can be trained using the training system 200 to prevent distributional biases and favoritism, e.g., when a language processing network generates skewed text more often about one group as opposed to another. As a particular example, a language processing network can generate biased responses more often about lawyers than software engineers, e.g., when examining a pool of sample responses generated per group. In this case, the population of adversarial LP networks 365 can be trained to generate adversarial prompts 310 that aim to widen the bias between two groups, e.g., the lawyers and software engineers, in order to train the base LP network 320 to perform more robustly with respect to distributional bias.

As an example, the base LP network 320 and the adversarial LP networks 365 can be derived from the same original pretrained large language model, e.g., each language processing network can be pretrained over a common language corpora and fine-tuned with supervision or reinforcement learning over a dataset of in-domain samples. More specifically, the base LP network 320 can be fine-tuned on standard dialogue data and human-generated adversarial dialogue data, and the population of adversarial neural networks can be fine-tuned on antagonistic dialogue data. As an example, the antagonistic dialogue data can include one or more curated antagonistic dialogue datasets, e.g., the Anthropic red-team dataset, the BAD dataset, etc. As another example, the antagonistic dialogue data can include antagonistic data generated with a variety of methods, e.g., those detailed in “Red Teaming Language Models with Language Models” (Perez, et. al.: arXiv:2202.03286).

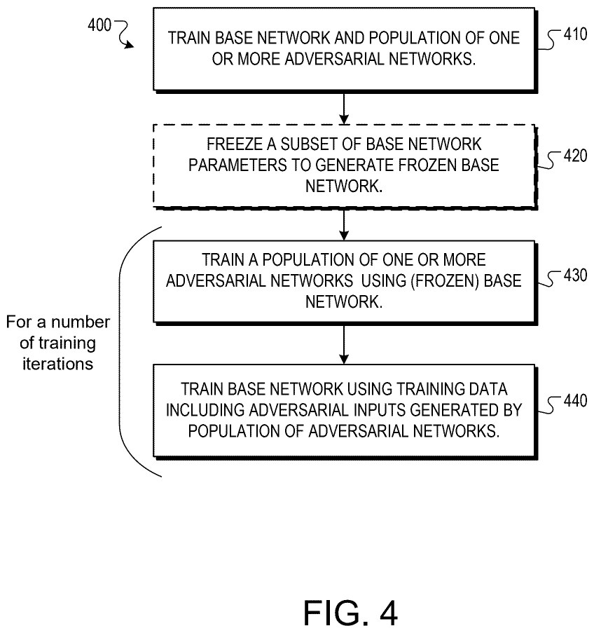

In particular, finetuning the networks 320 and 365 can involve updating a subset of the parameters of the respective models. An example of updating a subset of model parameters for a language processing model will be covered in more detail in FIG. 4, which presents an example hydra model that can be implemented as the base LP network 320 or one or more of the adversarial LP networks 365.

Panels 300 and 350 depict an overview of the reward scheme used to train the population of adversarial networks 365 and the base network 320, respectively, e.g., using the evolutionary adversarial reinforcement learning training system 200 of FIG. 2. In particular, the system can train the population of adversarial LP networks 365 to generate an increasingly diverse set of adversarial prompts 310 to target the alignment of the base LP prompt response 325 with the one or more downstream task criteria. The adversarial prompts 310 generated by the population 365 can enhance the overall performance of the base network 320 with respect to the downstream task criteria by increasing the robustness of the training process.

As depicted in panel 300, the base network 320 ingests data, e.g., a prompt. More specifically, the base LP network 320 can be configured to process prompts, e.g., adversarial prompts 310 or other prompts 315, to generate a prompt response as an output. The prompts can be maintained by a base network training subsystem, e.g., the base network training subsystem 105.

The other prompts 315 can include generic dialogue data 306, e.g., sourced from a language processing network training set or from scraping the internet. As an example, the other prompts 315 can be derived from dialogue training sets, e.g., human dialogue data collected from Prolific, compilations of dialogue datasets, and question-answering datasets converted into dialogue format. In particular, the other prompts 315 can include non-adversarial questions or statements for the base network 120, e.g., “what is the weather right now?” and “tips for cleaning a cast iron pan”.

The set of adversarial prompts 308 can include one or more adversarial outputs generated by the population of adversarial networks 365. In some cases, the adversarial prompts 310 can additionally include human-annotated prompts crafted to diversify the training prompts available to the base LP network 320.

In the particular example depicted, the base LP network 320 can process one of the adversarial prompts 310 to generate an adversarial prompt response 325. The adversarial prompt response 325 can then be processed by one or more reward models, e.g., the reward models 330. The reward models 330 can be configured to process the output of the base LP network 320, e.g., the adversarial prompt response 325, to generate one or more corresponding rewards with respect to the alignment of the adversarial prompt response 325 with one or more criteria including the downstream task criteria. As an example, the reward models 330 can be included in the criteria evaluation engine 140.

As an example, the reward models 330 can be reward language processing neural networks that have been trained to score text samples, e.g., prompt responses, with respect to one or more criteria, e.g., the downstream task criteria. Once trained, the reward models 330 can be frozen, e.g., the parameters can be kept constant at the most recently trained values and not updated during the reinforcement learning training process. In this case, the reward models 330 can simply serve as scoring models that can evaluate the output of the base LP network 320 during training of either the base network 320, the population of adversarial networks 365, or both.

In the particular example depicted, the downstream task criteria include one or more rule(s) criteria, e.g., a set of one or more rules that parametrize aspects of the downstream task, and a human preference criterion, that provides an indication of whether the response 330 aligns with human preference. In this case, the reward models 330 include a rules-based reward model 332 and preference-based reward model 334, which will be described in more detail below.

The rules-based reward model 332 can be trained to score text samples with respect to the rules. In particular, the rules-based reward model 332 can score the generated text, e.g., the adversarial prompt response 325, of the base LP network 320 by predicting the probability that a set of one or more rules that pertain to the downstream task criteria were violated. As an example, a set of one or more safety rules that parameterize safety criteria for the training of a base LP network 320 can include ensuring the prompt response is not offensive, avoids certain topics, prevents data leakage from the training set, protects sensitive information, etc. In some examples, the rules-based reward model 332 is a set of models, each trained to score text samples with respect to a respective rule. In other cases, the rules-based reward model 332 is a single model trained to score the text sample with respect to all the rules.

In particular, the rules-based reward model 332 can be trained using instruction-tuning to classify input text as having violated the set of rules or not, e.g., the training objective can maximize the likelihood of the sequence of tokens corresponding to an indication of violating a rule and cross-entropy loss over the tokens can be used for classification.

The human preference reward model 334 can be a Bradley-Terry (Elo) model that has been trained to predict an Elo preference score using the Elo training loss based on a comparison scale that indicates how much a human would prefer the response:

$${L}_{pr} = 𝔼 [ log \frac{exp ( {r}_{b} )}{{\sum }_{i} exp ( {r}_{i} )} ] + {β ( {\sum }_{i} {r}_{i} )}^{2} ,$$

where rᵢ are scalar reward values for each element i of the comparison scale and b is a particular element chosen. As an example, the comparison scale can range from two to five, e.g., where 2 indicates an output that is strongly not preferred and 5 indicates an output that is strongly preferred.

The rule and preference rewards 335 generated by the reward models 330 can inform the training of the base LP network 320. In the particular example depicted, the base reward 350 can include both a rules-based reward 346 and a preference-based reward 348. In particular, the base LP network 320 can incorporate the base reward 370 in a base reinforcement learning loss function, e.g., to penalize violations of the downstream task criteria and increase the preferability, e.g., as measured by the Elo preference score, of the prompt responses generated by the base network.

Panel 250 demonstrates how the adversarial reward can be formulated as the opposite of the base LP network's reward, therefore pitting the population of adversarial LP networks 365 against the base LP network 320. In particular, the population of adversarial networks 365 can generate an adversarial question 360 for the base LP network 320. As described in FIGS. 1 and 2, each adversarial network in the population 365 can be trained according to a respective training task that can involve causing the base network to violate one or more of the downstream task criteria.

In particular, the population of adversarial language networks 365 can be configured to process an adversarial input, e.g., the adversarial input 280, that can elicit harmful responses by language processing neural networks. More specifically, each of the adversarial networks 366, 368, and 370 can be configured to process adversarial inputs to generate adversarial outputs that can be processed by the base network 320 as adversarial prompts 310. The criteria evaluation engine 340 can then evaluate the prompt response 325 based on the ability of the base language process network 320 to perform robustly when faced with the generated adversarial prompts 310.

The adversarial networks 365 can receive a rule violation reward 370, e.g., from the rules-based reward model 332 or an additional rules-based reward model (not depicted). In particular, the rule violation reward 370 can relate a respective probability indicative of the adversarial prompt response 325 violating one or more of the downstream task criteria.

In a particular example in which the base LP network 320 and the population of adversarial LP networks 365 use the same rules-based reward model 332, the system can apply the rules-based reward in a different way for each model, e.g., such that the population of adversarial LP networks 365 can be rewarded in the opposite way of the base LP network 320. For example, the base LP network 320 can incorporate a function of the probability of rule violation from the rules-based reward model 332 to increase the base reinforcement learning loss in order to disincentivize rule violation, and the population of adversarial LP networks 365 can incorporate a function of the probability of rule violation in the adversarial reinforcement learning loss function to reduce the adversarial reinforcement learning loss function based on the measure of violating the one or more downstream task criteria.

FIG. 4 is a flow chart of an example process for jointly training a base network and an adversarial population of neural networks with respect to one or more downstream task criteria. As an example, the downstream task criteria can include an indicator for maintaining a stable output, fulfilling a set of safety criteria, adhering to quality control, e.g., an output not being distorted or noisy for image generation tasks, or preserving performance when faced with distributional shift. In particular, the one or more task criteria can aim to guardrail the base network output between allowable values, ensure that the output is harmless, and assert that performance in an unseen realm of input data remains acceptable.

For convenience, the process 400 will be described as being performed by a system of one or more computers located in one or more locations. For example, a training system, e.g., the alignment training system 100 of FIG. 1 or the evolutionary adversarial reinforcement learning training system 200 of FIG. 2, appropriately programmed in accordance with this specification, can perform the process 400.

The system can train a base network and a population of one or more adversarial networks (step 410), e.g., using supervision or reinforcement learning. In particular, the system can train the base network and the population of adversarial networks using relevant task data, e.g., generic task data for the base network and antagonistic data for the adversarial networks. In some cases, training using supervision can involve training models from the beginning. In other cases, e.g., a case in which both the base network and population of adversarial networks are language processing models, training can involve finetuning a subset of the parameters of a pretrained network. As an example, the system can train the base network and population of one or more adversarial networks as part of a zeroth iteration.

In some examples, the system can then freeze a subset of the base network, e.g., hold the parameters of the network constant, to generate a frozen base network (step 420). The system can use the frozen base network to train the population of adversarial networks, as is described in further detail below. In some cases, step 420 is an optional step, as is depicted by the dotted lines, and the system can train the population of adversarial networks using the unfrozen base network.

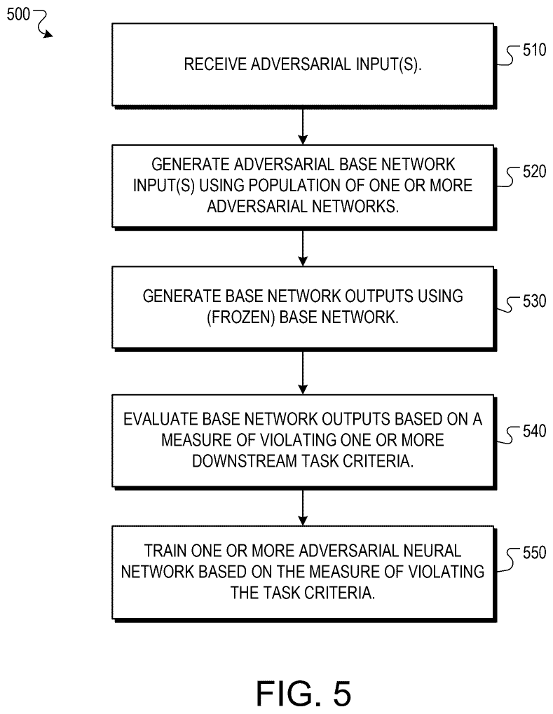

The system can train a population of one or more adversarial networks using the (frozen) base network (step 430). In particular, the adversarial networks can be trained using reinforcement learning. As an example, the adversarial networks can process one or more adversarial inputs to generate adversarial base network inputs that can be processed using the (frozen) base network to generate (frozen) base network outputs. The (frozen) base network outputs can then be evaluated based on a measure of a likelihood of violating one or more downstream task criteria, and the parameters of the population of adversarial networks can be updated in accordance with the evaluation of the frozen base network outputs, e.g., by formulating the measure of violating the downstream task criteria as an adversarial reward. The process of training the population of adversarial networks using a base network will be covered in more detail in FIG. 5. In some cases, the system can use the frozen base network to reduce distribution shift of the generated adversarial base network inputs between training iterations.

The system can then train the base network using training data including adversarial base network inputs generated by the population of adversarial networks in that training iteration (step 440). In particular, the base network can be trained using reinforcement learning. In this case, the system can jointly train both the base network and the population of adversarial networks together by formulating task rewards for each in a way that requires the base network and the population of adversarial networks to oppose each other, e.g., the system can apply the measure of violating one or more downstream task criteria in an opposite way from the adversarial reward as a base reward. In particular, the base reward can incentivize alignment of the output with the downstream task criteria, e.g., by being incorporated into a base reinforcement learning loss function.

The steps 430 and 440 can be repeated for a number of training iterations. In a particular example, the system can train the population of adversarial neural networks using the (frozen) base network to evolve the adversarial network in order to generate evolving adversarial data that can enhance base network performance, e.g., with respect to the downstream task criteria. More specifically, the system can enhance the training of the base network such that the base network can perform robustly even when processing adversarial data as an input, e.g., the system can train the population of adversarial neural networks to generate more targeted and diverse adversarial data to ensure that the output of the base network aligns with the downstream task criteria.

FIG. 5 is a flow chart of an example process for training an adversarial population of neural networks to generate robust data for training a base network with respect to one or more downstream task criteria. As an example, the system can perform the process 500 as part of

For convenience, the process 500 will be described as being performed by a system of one or more computers located in one or more locations. For example, a training system, e.g., the alignment training system 100 of FIG. 1 or the evolutionary adversarial reinforcement learning training system 200 of FIG. 2, appropriately programmed in accordance with this specification, can perform the process 500 as part of step 430 of FIG. 4.

The system can receive one or more adversarial inputs (step 510) and generate one or more adversarial base network inputs by processing the adversarial inputs using a population of one or more adversarial neural networks (step 520). The adversarial inputs can include adversarial data that is curated with respect to the downstream tasks, e.g., by upweighting the outliers of a population of data, by including purposefully antagonistic data, etc.

Each adversarial neural network can have any appropriate machine learning architecture, e.g., each adversarial neural network can be configured to process an adversarial input to generate an adversarial output that can be processed by a base network as an adversarial base network input, as described below. The one or more adversarial networks can be included as part of a population of adversarial networks. In some cases, each of the population of adversarial networks can be trained according to a respective training task to violate one or more downstream task criteria. More specifically, the adversarial neural networks can function as a unit, e.g., a cooperative league, to oppose the base network.

The population of adversarial neural networks can be trained according to an adversarial training task strategy. As an example, one adversarial neural network can be trained in accordance with an adversarial training task to violate all of the downstream task criteria. In another case, the population of adversarial networks can be partitioned into subsets of one or more adversarial networks and trained with an adversarial task to target a specific subset of the downstream task criteria. In yet another example, each of the adversarial networks can be trained to target a specific downstream task criterion.

In some cases, either the base network, one or more adversarial networks, or both can be language processing networks, e.g., transformer large language models. In this case, the adversarial inputs can include inputs from datasets that have been crafted to elicit harmful responses by language processing networks, e.g., the Anthropic red-team dataset, the BAD dataset, etc., As another example, the antagonistic dialogue data can include antagonistic data generated with a variety of methods, e.g., those detailed in Perez, et. al.: “Red Teaming Language Models with Language Models”.

The system can then generate one or more base network outputs using a (frozen) base network (step 530), e.g., by processing input data that includes the adversarial base network inputs. As discussed in FIG. 5, in some cases the system can process the input data using a frozen base network. The system can evaluate the one or more base network outputs based on a measure of a likelihood of violating one or more downstream task criteria (step 540). For example, the system can process the adversarial data to generate one or more adversarial base network outputs that can be evaluated to provide feedback to both the base network and the one or more adversarial networks.

The system can evaluate the base network outputs using a criteria evaluation engine. In some cases, evaluating can involve using one or more reward models to score the output of the base network with respect to the one or more downstream task criteria. In other cases, evaluating can involve using a logic-based system that compares the base network outputs to the one or more downstream task criteria.

The system can then train the population of adversarial neural networks based at least on the measure of violating the downstream task criteria (step 550). As an example, the system can provide the measure of violating the downstream task criteria as feedback for the one or more adversarial networks. In some cases, the feedback can also be provided to train the base network. In a particular example, the measure of violating the downstream task criteria can be used as a reward in an adversarial reinforcement learning scheme, e.g., as a reward that can be incorporated in an adversarial reinforcement learning loss.

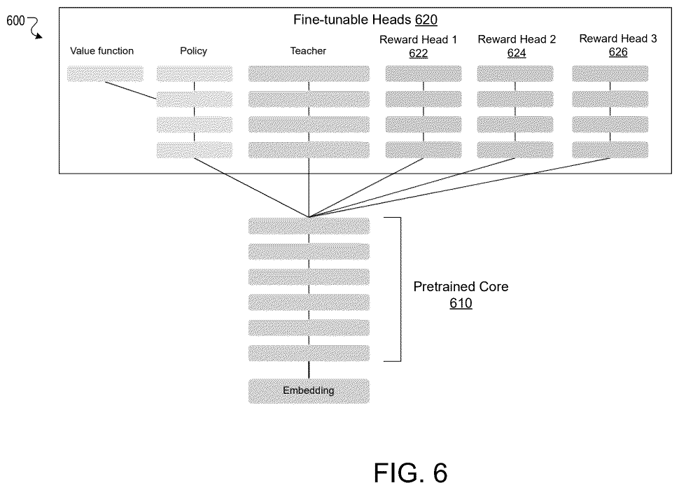

FIG. 6 depicts an example language processing network that can be implemented as either the base language processing network, one or more of the population of adversarial language processing networks, or both. The hydra model 600 includes a pretrained core 610 that can be shared amongst one or more fine-tunable heads 620.

More specifically, the hydra model can include a pretrained core 610, e.g., a set of parameters that can frozen during finetuning, and a set of one or more fine-tunable heads 620, e.g., respective sets of parameters that can be updated during finetuning. In an example in which the evolutionary adversarial reinforcement training system 300 jointly trains a base hydra model and a population of adversarial hydra models, the system can finetune each of the heads 620 during each training iteration.

Each fine-tunable head can contain a respective set of updatable parameters, e.g., the parameter values of each head can differ from one another. In particular, processing an input with the hydra model 600 can involve processing the data with the pretrained core 610 and then processing the intermediate output from the core 610 using the one or more fine-tunable heads 620. In some cases, the system can parallelize the processing of the intermediate output with the fine-tunable heads 620, e.g., using a job-scheduler.

The structure of the hydra model 600 can provide clear separation between the pretrained parameters and the fine-tunable parameters of the model 600, as well as clear separation between different model training tasks. In the particular example depicted, the hydra model 600 can include different fine-tunable heads 620 specialized for different reinforcement learning tasks. For example, the one or more fine-tunable heads 620 can include a policy, value, teacher policy, and one or more criteria reward heads, e.g., reward head 1 622, reward head 2 624, and reward head 3 626. In particular, the one or more fine-tunable heads 620 can be configured to process the intermediate output to generate respective outputs. For example, the policy head can be configured to process the intermediate output of the core to generate a prompt response, e.g., a probability distribution over next text tokens, and the value head can be configured to generate a prediction of the maximal reward that can be achieved by the prompt response. As another example, the teacher policy head can generate a reference prompt response comprising a pre-fine-tuned comparison baseline for the prompt response, e.g., a pre-fine-tuned comparison to maintain stable policy training by ensuring the parameters of the policy head do not excessively diverge from the pre-fine-tuned policy. As yet another example, the one or more reward heads can be configured to determine one or more respective rewards for the base network output, e.g., the adversarial or base network rewards.

The student policy, teacher policy, and value heads can be fine-tuned using any teacher-student reinforcement learning technique that uses a lagged policy model to ensure stability of policy training, e.g., A2C, and the criteria reward heads 622, 624, and 626 can be fine-tuned based on rewards that include a respective measure of violating the set of one or more downstream task criteria. In some cases, the criteria reward heads 622, 624, and 626 can be frozen reward models that have been trained to score the output of the policy head. In this case, the parameters of the reward models are not fine-tuned, e.g., the criteria reward heads 622, 624, 626 are not updated during training.

More specifically, the number of reward heads can correspond with the rewards received by each model, e.g., in some cases, the base network and the adversarial networks do not receive the same number of rewards. In the example in which the base language processing network 320 of FIG. 3 is a hydra model, the one or more reward heads can include a human preference reward and two rules-based reward heads. In the example in which one or more of the adversarial language processing networks of the population 365 of FIG. 3 are a hydra model, the one or more reward heads can include two rules-based reward heads.

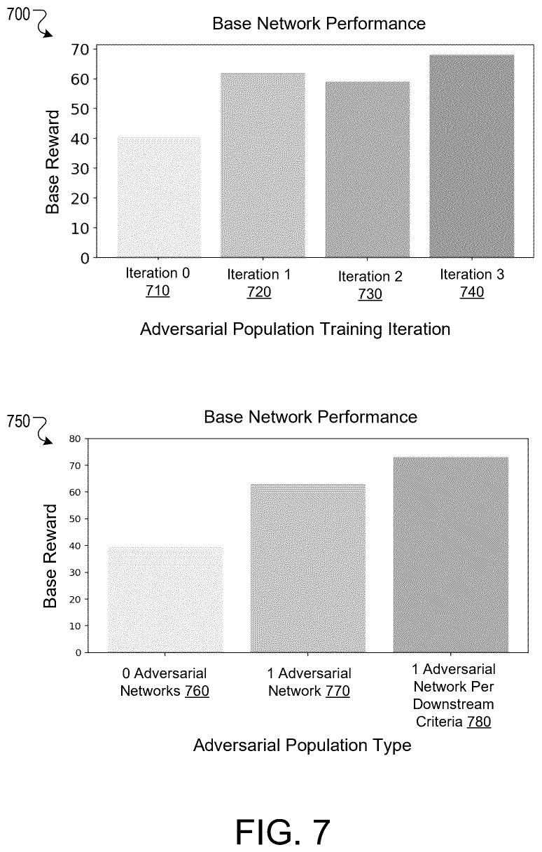

FIG. 7 depicts results from training a base network using the evolutionary adversarial reinforcement learning training system as described in FIG. 2.

In particular, graph 700 illustrates how the base network performance, e.g., as measured by the base network reward, improves after several iterations of adversarial population training. In particular, graph 700 demonstrates how training the evolving population of adversarial neural networks to generate adversarial prompts improves the robustness of the base network performance as can be seen by the overall trend of increasing reward as the population is trained for an increasing number of iterations from iteration 0 710 to iteration 3 740. Even though the base network reward at iteration 2 730 achieved slightly less reward than the base network reward at iteration 1 720, the overall trend demonstrates a correlation between increasing performance and increasing training iterations.

Graph 750 illustrates how the adversarial population type corresponds with base network performance. More specifically, graph 750 demonstrates how diversifying the population of adversarial networks to train with an adversarial training task that targets specific downstream task criteria can enable the generation of new and more diverse adversarial data for training, e.g., as measured by base network performance.

In particular, graph 750 demonstrates how introducing a population of one adversarial network 770, e.g., one adversarial network trained to target all of the downstream task criteria can result in a base network reward increase of 150%, e.g., when compared to a base network training system without augmented training data generated by one or more adversarial networks 760.

Furthermore, the inclusion of a population of adversarial networks, wherein each adversarial network is trained in accordance with a respective training task to violate a specific downstream task criterion 780, can further enhance the performance of the base network with respect to training the base network with the population of one adversarial network 770. In particular, partitioning the adversarial training task into respective adversarial training tasks for each of the population of adversarial neural networks to target each of the downstream criteria increases the performance of the base network, although not as much as the base network performance gain from including the single adversarial population 770.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method for training a population of adversarial neural networks using a base neural network, wherein training the population comprises, at each of a plurality of training iterations and for each adversarial neural network in the population:
receiving an adversarial input;
processing the adversarial input using the adversarial neural network to generate one or more adversarial base network inputs for the base neural network, wherein each adversarial base network input is generated in accordance with a respective training task that requires generating adversarial base network inputs that violate the one or more downstream task criteria;
processing the one or more adversarial base network inputs using the base neural network to generate one or more respective adversarial base network outputs for each adversarial base network input;
determining one or more adversarial rewards for the adversarial base network outputs that each measure a likelihood that the outputs violate a corresponding set of one or more downstream task criteria; and
training the adversarial neural network in accordance with the respective training task by optimizing an adversarial reinforcement learning loss function based at least on the adversarial reward.

Embodiment 2 is the method of embodiment 1, wherein the adversarial input comprises data that the adversarial neural network can process to generate adversarial base network inputs in accordance with causing the base neural network to generate base network outputs that violate at least one of the downstream task criteria.

Embodiment 3 is the method of any one of embodiments 1-2, wherein each adversarial neural network in the population has been assigned a respective training task comprising causing the base neural network to violate a respective first downstream task criterion, and wherein the adversarial reward for the adversarial neural network comprises a respective measure of a likelihood that the one or more base network outputs violate the respective first downstream task criterion.

Embodiment 4 is the method of any one of embodiments 1-3, further comprising training the base neural network at each of a second plurality of iterations using one or more adversarial base network inputs generated by at least one adversarial neural network of the population.

Embodiment 5 is the method of embodiment 4, wherein training the base neural network comprises training the base neural network using reinforcement learning, comprising, at each of the second plurality of training iterations:
receiving a plurality of inputs comprising the one or more generated adversarial base network inputs;
generating one or more base network outputs for each of the plurality of inputs;
determining one or more base rewards for the base network outputs that each measure a likelihood that the outputs violate a corresponding set of one or more downstream task criteria; and
training the base neural network by optimizing a base reinforcement learning loss function based at least on the base reward.

Embodiment 6 is the method of embodiment 5, wherein the plurality of inputs further comprises one or more base inputs that were not generated by the population of adversarial neural networks.

Embodiment 7 is the method of any one of embodiments 5-6, further comprising generating the adversarial reward and the base reward using one or more reward models.

Embodiment 8 is the method of embodiment 7, wherein each of the one or more reward models comprise a reward language processing neural network that has been trained to score text samples with respect to one or more criteria.

Embodiment 9 is the method of any one of embodiments 7-8, wherein using one or more reward models comprises:
using a rule reward model to determine a respective probability of the adversarial base network output violating a set of rules corresponding with the one or more downstream task criteria; and
using a preference reward model to determine a preference score as a measure of one or more human preference criteria.

Embodiment 10 is the method of any of embodiments 1-9, wherein the base neural network and each adversarial neural network in the population comprise language processing models.

Embodiment 11 is the method of embodiment 10, wherein the base neural network and each adversarial neural network in the population comprise attention-based language models.

Embodiment 12 is the method of embodiment 11, wherein each attention-based language model comprises:
a shared core having one or more pretrained parameters configured to process an input and generate an intermediate output; and
one or more heads, each comprising a set of fine-tunable parameters, configured to process the intermediate output of the shared core.

Embodiment 13 is the method of embodiment 12, wherein the one or more heads comprise:
a policy head configured to process the intermediate output to generate a prompt response comprising a probability distribution over next text tokens in a sequence of text tokens as the base network output;
a value head configured to process the intermediate output to generate a value comprising a prediction of a maximal reward that can be achieved by the prompt response;
a teacher policy head configured to process the intermediate output to generate a reference prompt response comprising a pre-fine-tuned comparison baseline for the prompt response; and
one or more reward heads configured to determine one or more respective rewards for the base network output.

Embodiment 14 is the method of embodiment 13, wherein the one or more reward heads generate the one or more adversarial rewards.

Embodiment 15 is the method of any one of embodiments 13-14, wherein the one or more reward heads generate the one or more base rewards.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a population of adversarial neural networks using a base neural network, wherein training the population comprises, at each of a plurality of training iterations and for each adversarial neural network in the population:
receiving an adversarial input;
processing the adversarial input using the adversarial neural network to generate one or more adversarial base network inputs for the base neural network, wherein each adversarial base network input is generated in accordance with a respective training task that requires generating adversarial base network inputs that violate the one or more downstream task criteria;
processing the one or more adversarial base network inputs using the base neural network to generate one or more respective adversarial base network outputs for each adversarial base network input;
determining one or more adversarial rewards for the adversarial base network outputs that each measure a likelihood that the outputs violate a corresponding set of one or more downstream task criteria; and
training the adversarial neural network in accordance with the respective training task by optimizing an adversarial reinforcement learning loss function based at least on the adversarial reward.

2. The method of claim 1, wherein the adversarial input comprises data that the adversarial neural network can process to generate adversarial base network inputs in accordance with causing the base neural network to generate base network outputs that violate at least one of the downstream task criteria.

3. The method of claim 1, wherein each adversarial neural network in the population has been assigned a respective training task comprising causing the base neural network to violate a respective first downstream task criterion, and wherein the adversarial reward for the adversarial neural network comprises a respective measure of a likelihood that the one or more base network outputs violate the respective first downstream task criterion.

4. The method of claim 1, further comprising training the base neural network at each of a second plurality of training iterations using one or more adversarial base network inputs generated by at least one adversarial neural network of the population.

5. The method of claim 4, wherein training the base neural network comprises training the base neural network using reinforcement learning, comprising, at each of the second plurality of training iterations:
receiving a plurality of inputs comprising the one or more generated adversarial base network inputs;
generating one or more base network outputs for each of the plurality of inputs;
determining one or more base rewards for the base network outputs that each measure a likelihood that the outputs violate a corresponding set of one or more downstream task criteria; and
training the base neural network by optimizing a base reinforcement learning loss function based at least on the base reward.

6. The method of claim 5, wherein the plurality of inputs further comprises one or more base network inputs that were not generated by the population of adversarial neural networks.

7. The method of claim 5, further comprising generating the adversarial reward and the base reward using one or more reward models.

8. The method of claim 7, wherein each of the one or more reward models comprise a reward language processing neural network that has been trained to score text samples with respect to one or more criteria.

9. The method of claim 7, wherein using one or more reward models comprises:
using a rule reward model to determine a respective probability of the adversarial base network output violating a set of rules corresponding with the one or more downstream task criteria; and
using a preference reward model to determine a preference score as a measure of one or more human preference criteria.

10. The method of claim 1, wherein the base neural network and each adversarial neural network in the population comprise language processing models.

11. The method of claim 10, wherein the base neural network and each adversarial neural network in the population comprise attention-based language models.

12. The method of claim 10, wherein each attention-based language model comprises:
a shared core having one or more pretrained parameters configured to process an input and generate an intermediate output; and
one or more heads, each comprising a set of fine-tunable parameters, configured to process the intermediate output of the shared core.

13. The method of claim 12, wherein the one or more heads comprise:
a policy head configured to process the intermediate output to generate a prompt response comprising a probability distribution over next text tokens in a sequence of text tokens as the base network output;
a value head configured to process the intermediate output to generate a value comprising a prediction of a maximal reward that can be achieved by the prompt response;
a teacher policy head configured to process the intermediate output to generate a reference prompt response comprising a pre-fine-tuned comparison baseline for the prompt response; and
one or more reward heads configured to determine one or more respective rewards for the base network output.

14. The method of claim 13, wherein the one or more reward heads generate the one or more adversarial rewards.

15. The method of claim 13, wherein the one or more reward heads generate the one or more base rewards.
